(19) United States
(12) Patent Application Publication
(10) Pub. No.: US 2024/0001389 A1
(43) Pub. Date: Jan. 4, 2024

(54) AMPLITUDE-MODULATING ASSEMBLY FOR PNEUMATIC SPRAY GUN

(71) Applicant: Zhejiangg Rong pen ,Ajr Tools Co., Ltd., Taizhou (CN)

(72) Inventors: Jiaxue Zhou, Taizhou (CN); Hai Wu, Taizhou (CN); Fazheng Yang, Taizhou (CN); Xiaorong Li, Taizhou (CN)

(21) Appl. No.: 17/823,484

(22) Filed: Aug. 30, 2022

(30) Foreign Application Priority Data
Jun. 29, 2022 (CN) 202221642920.X

(51) Int. Cl. B05B 12/00; B05B 7/12

(52) U.S. Cl. CPC B05B 12/002; B05B 7/1218; B05B 7/1263

(57) ABSTRACT

An improved amplitude-modulating assembly for pneumatic spray guns. The amplitude-modulating assembly is configured inside the amplitude-modulating passage of the gun body, comprising an amplitude-modulating screw seat fixed with the gun body, and an amplitude-modulating rod going through the amplitude-modulating screw seat and in threaded connection with the amplitude-modulating screw seat. An amplitude-modulating seal ring is configured between the amplitude-modulating rod and the amplitude-modulating screw seat. The middle portion of the amplitude-modulating rod is configured with a clamping check ring. The clamping check ring is used to limit the position of the amplitude-modulating rod. The inner end of the amplitude-modulating rod is the amplitude-modulating portion. The amplitude-modulating portion is formed with a first inclined surface and a second inclined surface tilting toward the axis.

### BACKGROUND OF INVENTION

### 1. Field of the Invention

The present invention relates to an improved amplitude-modulating assembly for a pneumatic spray gun.

### 2. Description of Related Art

A pneumatic spray gun is a spraying device powered by compressed air. Compressed air is supplied from the air inlet tube into the gun body. When the high-pressure compressed air is ejected from the air cap on the front portion of the spray gun, a zone of negative pressure lower than the atmosphere pressure is created in front of the paint nozzle. Due to the pressure difference in front of the muzzle, the paint is sucked out from the paint storage tank and is atomized into tiny particles by the high-speed ejected compressed air, thus being coated on the surface to be painted. The technology of pneumatic spray guns is already quite mature. However, manufacturers are still making effort in further improvements in terms of optimized structure, better performance, longer life cycle, lower production cost, simplified assembly etc., with a view to maintaining their competitive edge in the market.

In the conventional pneumatic spray gun, the amplitude-modulating assembly is usually configured inside the amplitude-modulating passage of the gun body. The amplitude-modulating rod moves axially to adjust the opening of the air passage. The spray range of the air cap can be adjusted gradually from sector shape to round shape. Researchers have found that, when the air flow passes the free end of the amplitude-modulating rod and the inner wall of the amplitude-modulating passage, the air flow becomes partially disordered and inhibited.

### SUMMARY OF THE INVENTION

in view of the deficiencies in the above problems, the present invention provides an improved amplitude-modulating assembly for pneumatic spray gun.

In order to achieve the above object, the present invention provides an improved amplitude-modulating assembly for a pneumatic spray gun, wherein the amplitude-modulating assembly is arranged in an amplitude-modulating passage of a gun body, and comprises an amplitude-modulating screw seat fixedly connected with the gun body, an amplitude-modulating rod inserted into the amplitude-modulating screw seat and screwed to the amplitude-modulating screw seat through threads, an amplitude-modulating seal ring disposed between the amplitude-modulating rod and the amplitude-modulating screw seat, a clamping check ring disposed in a middle portion of the amplitude-modulating rod and used to limit the position of the amplitude-modulating rod, wherein an inner end of the amplitude-modulating rod is an amplitude-modulating portion, the amplitude-modulating portion is formed with a first inclined surface and a second inclined surface which are inclined toward an axis line.

More particularly, wherein an outer end of the amplitude-modulating rod is fixed with an amplitude-modulating cap through a screw, the amplitude-modulating screw seat has a shoulder to interact with the amplitude-modulating cap, the shoulder is used to limit the position of the amplitude-modulating rod.

More particularly, wherein the included angle between the first inclined surface and the axis of the amplitude-modulating rod is 15 degrees, and the included angle between the second inclined surface and the axis of the amplitude-modulating rod is 53.75 degrees.

More particularly, wherein the amplitude-modulating screw seat is in threaded connection with the gun body and is sealed, the outer end of the amplitude-modulating screw seat is configured with a hex head, and the hex head is hidden inside the amplitude-modulating cap.

Comparing to the prior art, the present invention has the following benefits: The structure of the amplitude-modulating assembly is improved to allow two or more than two angle gradients for the amplitude-modulating portion, resulting in more smooth air flow when it works inside the amplitude-modulating passage of the gun body, so as to reduce fluctuation and create uniform atomized particles. The existing amplitude-modulating screw seat usually has a hex head configured in the middle, whereas in the present invention, the hex head is configured at the outer end of the amplitude-modulating screw seat and is covered by the amplitude-modulating cap, contributing to better appearance of the product.

### BRIEF DESCRIPTION OF THE DRAWINGS

FIG. 1 is a perspective view of a pneumatic spray gun configured with an amplitude-modulating assembly according to the present invention;

FIG. 2 is a sectional view of FIG. 1;

FIG. 3 is an enlarged view of the amplitude-modulating assembly in FIG. 2;

FIG. 4 is a perspective view of the amplitude-modulating assembly according to the present invention;

FIG. 5 is an exploded view of the amplitude-modulating assembly according to the present invention.

### DETAILED DESCRIPTION OF THE INVENTION

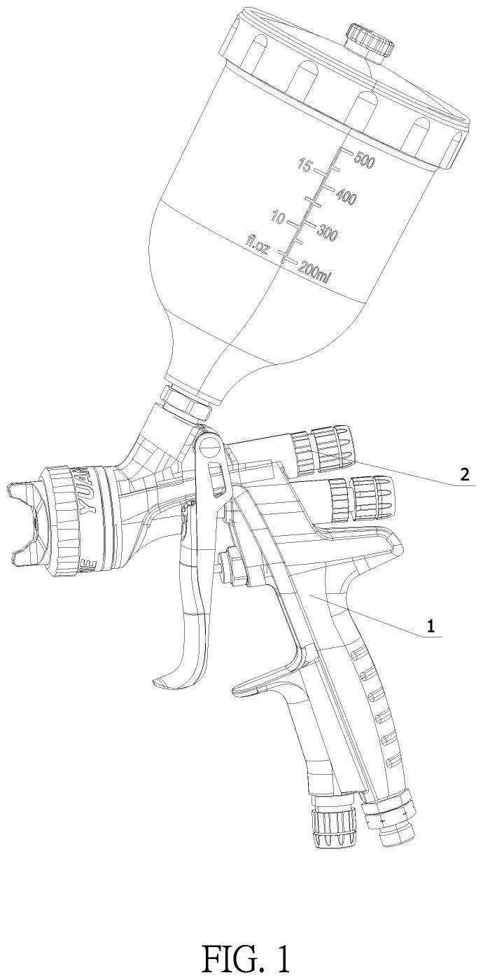

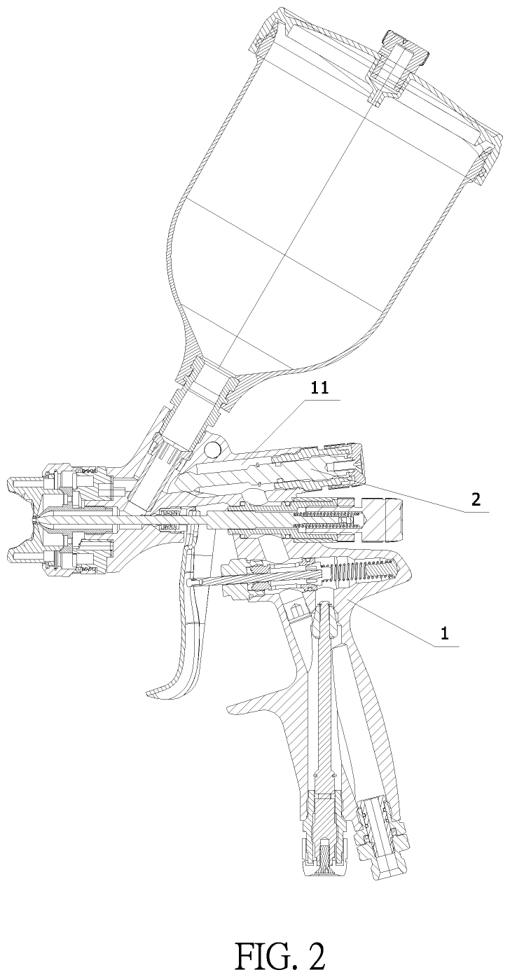

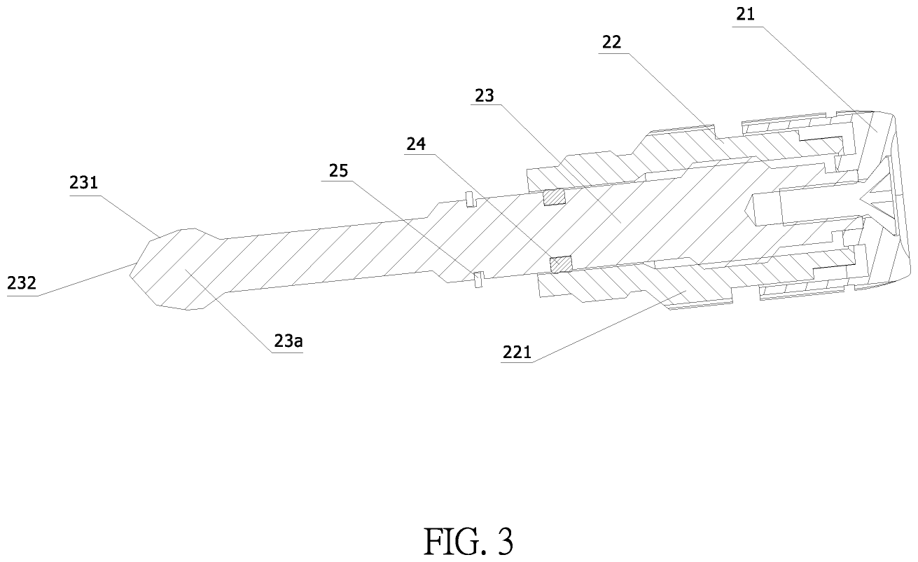

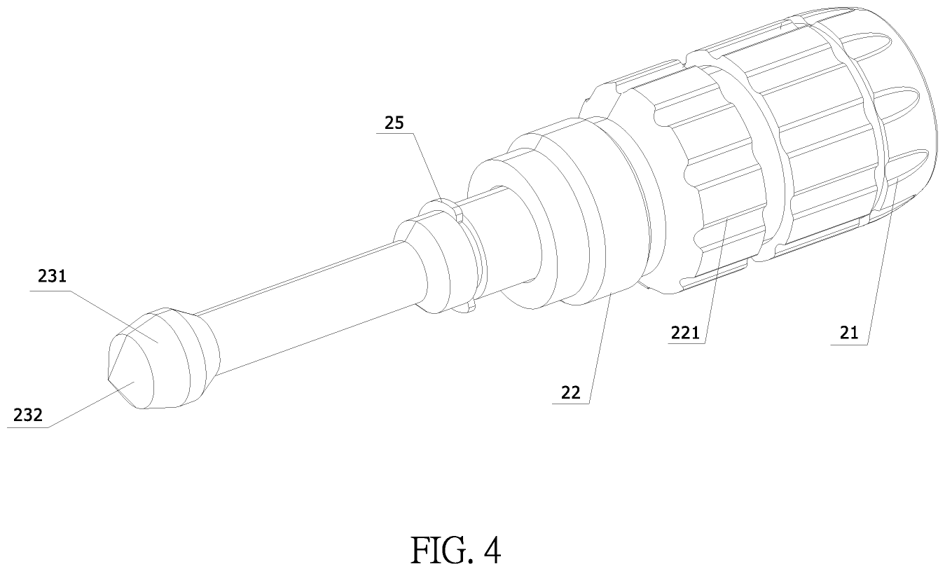

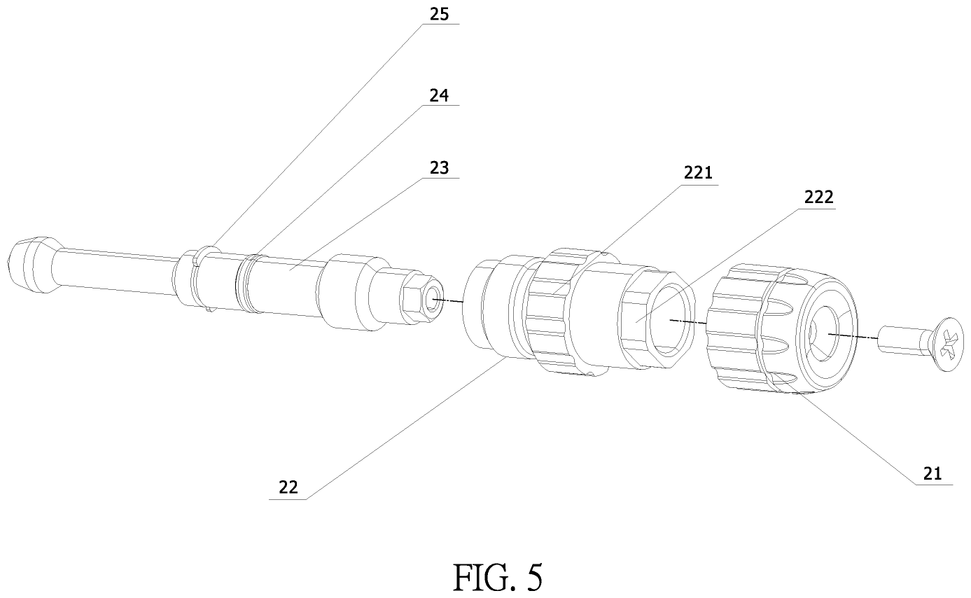

Depicted in FIGS. 1-5 is an amplitude-modulating assembly for pneumatic spray guns. The amplitude-modulating assembly 2 is configured inside the amplitude-modulating passage 11 of the gun body 1, comprising an amplitude-modulating screw seat 22 fixed with the gun body 1, an amplitude-modulating rod 23 going through the amplitude-modulating screw seat 22 and in threaded connection with the amplitude-modulating screw seat 22. An amplitude-modulating seal ring 24 is configured between the amplitude-modulating rod 23 and the amplitude-modulating screw seat 22. The middle portion of the amplitude-modulating rod 23 is configured with a clamping check ring 25. The clamping check ring 25 is used to limit the position of the amplitude-modulating rod 23. The inner end of the amplitude-modulating rod 23 is an amplitude-modulating portion 23a. The amplitude-modulating portion 23a is formed with a first inclined surface 231 and a second inclined surface 232 tilting toward the axis. The outer end of the amplitude-modulating rod 23 is fixed with an amplitude-modulating cap 21 through a screw. The amplitude-modulating screw seat 22 has a shoulder 221 that interacts with the amplitude-modulating cap 21. The shoulder 221 is used to limit the position of the amplitude-modulating rod 23. Through the amplitude-modulating cap, the amplitude-modulating rod can be easily rotated. When working with the shoulder, the amplitude-modulating cap also offers the positioning function. The included angle between the first inclined surface 23 land the axis of the amplitude-modulating rod 23 is 15 degrees, whereas the included angle between the second inclined surface 232 and the axis of the amplitude-modulating rod 23 is 53.75 degrees. The first inclined surface adopts a small inclination angle, whereas the second inclined surface adopts a large inclination angle. When the air flow passes the position of the amplitude-modulating portion, the sectional area of the air flow is gradually increased and the air flow is gentle with limited fluctuation. The amplitude-modulating screw seat 22 is in threaded connection with the gun body 1 and is sealed. The outer end of the amplitude-modulating screw seat 22 is configured with a hex head 222. The hex head. 222 is hidden inside the amplitude-modulating cap 21. The hex head facilitates the connection between the amplitude-modulating screw seat and the gun body. The design of a hidden hex head can improve the overall appearance of the amplitude-modulating assembly.

The present invention made a structural improvement to the amplitude-modulating assembly 2. The amplitude-modulating, portion adopts a structure with two or more than two angle gradients. When working with the amplitude-modulating passage of the gun body 1, the air flow becomes more smooth. As a result, the atomization will have less fluctuation and the atomized particles will be more uniform. The existing amplitude-modulating screw seat is usually configured with a hex head in the middle portion, whereas in the present invention, the hex head 222 is configured on the outer end of the amplitude-modulating screw seat 22 and is covered by the amplitude-modulating cap 21 for better appearance.

The usage of the present invention is detailed as below:

When the compressed air enters the gun body 1 and reaches the amplitude-modulating passage 11, through the axial movement of the amplitude-modulating rod 23, the spraying range of the air cap can be adjusted. When the high-pressure air passes through the amplitude-modulating portion 23a and the area enclosed by the inner wall of the amplitude-modulating passage 11, the air flow along the first inclined surface 231 and the second inclined surface 232. As the first inclined surface and the second inclined surface are tilted toward the axis of the amplitude-modulating rod 23, the sectional area of the air flow is gradually increased and the air flow becomes more smooth with less fluctuation.

We claim:

1. An improved amplitude-modulating assembly for a pneumatic spray gun, wherein the amplitude-modulating assembly (2) is arranged in an amplitude-modulating passage (11) of a gun body (1), and comprises
an amplitude-modulating screw seat (22) fixedly connected with the gun body (1),
an amplitude-modulating rod (23) inserted into the amplitude-modulating screw seat (22) and screwed to the amplitude-modulating screw seat (22) through threads,
an amplitude-modulating seal ring (24) disposed between the amplitude-modulating rod (23) and the amplitude-modulating screw seat (22),
a clamping check ring (25) disposed in a middle portion of the amplitude-modulating rod (23) and used to limit the position of the amplitude-modulating rod (23),
wherein an inner end of the amplitude-modulating rod (23) is an amplitude-modulating portion (23a), the amplitude-modulating portion (23a) is formed with a first inclined surface (231) and a second inclined surface (232) which are inclined toward an axis line.

2. The improved amplitude-modulating component for the pneumatic spray gun defined in claim 1, wherein an outer end of the amplitude-modulating rod (23) is fixed with an amplitude-modulating cap (21) through a screw, the amplitude-modulating screw seat (22) has a shoulder (221) to interact with the amplitude-modulating cap (21), the shoulder (221) is used to limit the position of the amplitude-modulating rod (23).

3. The improved amplitude-modulating component for the pneumatic spray gun defined in claim 2, wherein the included angle between the first inclined surface (231) and the axis of the amplitude-modulating rod (23) is 15 degrees, and the included angle between the second inclined surface (232) and the axis of the amplitude-modulating rod (23) is 53.75 degrees.

4. The improved amplitude-modulating component for the pneumatic spray gun defined in claim 3, wherein the amplitude-modulating screw seat (22) is in threaded connection with the gun body (1) and is sealed, the outer end of the amplitude-modulating screw seat (22) is configured with a hex head (22), and the hex head (22) is hidden inside the amplitude-modulating cap (21).
